(19) United States
(12) Patent Application Publication
(10) Pub. No.: US 2016/0055641 A1
(43) Pub. Date: Feb. 25, 2016

(54) SYSTEM AND METHOD FOR SPACE FILLING REGIONS OF AN IMAGE

(71) Applicant: KISP INC., North York (CA)

(72) Inventors: Lev FAYNSHTEYN, North York (CA); Ian HALL, Oakville (CA)

(21) Appl. No.: 14/465,483

(22) Filed: Aug. 21, 2014

(51) Int. Cl. G06T 7/00; G06T 11/40; G06T 7/60; H04N 5/272

(52) U.S. Cl. CPC G06T 7/0044; H04N 5/272; G06T 11/40; G06T 7/0018; G06T 7/60

(57) ABSTRACT

A system and method for space filling regions of an image of a physical space are provided. Various algorithms and transformations enable a rendering unit in communication with an image capture device to generate visual renderings of a physical space from which obstacles have been removed.

### TECHNICAL FIELD

The following relates generally to image processing and more specifically to space filling techniques to render a region of an image of a physical space using other regions of the image.

### BACKGROUND

In design fields such as, for example, architecture, interior design, and interior decorating, renderings and other visualisation techniques assist interested parties, such as, for example, contractors, builders, vendors and clients, to plan and validate potential designs for physical spaces.

Designers commonly engage rendering artists in order to sketch and illustrate designs to customers and others. More recently, designers have adopted various digital rendering techniques to illustrate designs. Some digital rendering techniques are more realistic, intuitive and sophisticated than others.

When employing digital rendering techniques to visualise designs applied to existing spaces, the rendering techniques may encounter existing elements, such as, for example, furniture, topography and clutter, in those spaces.

### SUMMARY

In visualising a design to an existing physical space, it is desirable to allow a user to capture an image of the existing physical space and apply design changes and elements to the image. However, when the user removes an existing object shown in the image, a void is generated where the existing object stood. The void is unsightly and results in a less realistic rendering of the design.

In one aspect, a system is provided for space filling regions of an image of a physical space, the system comprising a rendering unit operable to generate a tileable representation of a sample region of the image and replicating the tileable representation across a target region in the image.

In another aspect, a method is provided for space filling regions of an image of a physical space, the method comprising: (1) in a rendering unit, generating a tileable representation of a sample region of the image; and (2) replicating the tileable representation across a target region in the image.

In embodiments, a system is provided for assigning world coordinates to at least one point in an image of a physical space captured at a time of capture by an image capture device. The system comprises a rendering unit configured to: (i) ascertain, for the time of capture, a focal length of the image capture device; (ii) determine, in world coordinates, for the time of capture, an orientation of the image capture device; (iii) determine, in world coordinates, for the time of capture, a distance between the image capture device and a reference point in the physical space; and (iv) generate a view transformation matrix comprising matrix elements determined by the focal length, the orientation and the distance to enable transformation between the coordinate system of the image and the world coordinates.

In further embodiments, the system for assigning world coordinates is configured to space fill regions of the image, the rendering unit being further configured to: (i) select, based on user input, a sample region in the image; (ii) map the sample region to a reference plane; (iii) generate a tileable representation of the sample region; (iv) select, based on user input, a target region in the reference plane; and (v) replicate the tileable representation of the sample region across the target region.

In still further embodiments, the rendering unit is configured to determine the distance between the image capture device and the reference point by: (i) causing a reticule to be overlaid on the image using a display unit; (ii) obtaining from a user by a user input device the known length and orientation in world coordinates of a line corresponding to a captured feature of the physical space; (iii) adjusting the location and size of the reticule with respect to the image in response to user input provided by the user input device; (iv) obtaining from the user by the user input device an indication that the reticule is aligned with the line; and (iv) determining the distance from the image capture device to the reference point, based on the size and orientation of the reticule and the size and orientation of the line.

In embodiments, the rendering unit is configured to determine the distance from the image capture device to the reference point by: (i) determining that a user has placed the image capture device on a reference plane; (ii) determining the acceleration of the image capture device as the user moves the image capture device from the reference plane to an image capture position; (iii) deriving the distance of the image capture device from the reference plane from the acceleration; and (iv) determining the distance between the image capture device and the reference point, based on the focal length of the image capture device and the distance of the image capture device from the reference plane.

In further embodiments, the rendering unit is configured to determine the distance from the image capture device to the reference point by requesting user input of an estimated distance from the image capture device to a reference plane.

In yet further embodiments, the rendering unit determines the orientation in world coordinates of the image capture device by: (i) obtaining acceleration of the image capture device from an accelerometer of the image capture device; (ii) determining from the acceleration when the image capture device is at rest; and (iii) assigning the acceleration at rest as a proxy for the orientation in world coordinates of the image capture device.

In embodiments, the rendering unit generates the tileable representation of the sample region by using a Poisson gradient-guided blending technique. The tileable representation of the sample region may comprise four sides and the rendering unit enforces identical boundaries for all four sides of the tileable representation of the sample region.

In further embodiments, the rendering unit replicates the tileable representation of the sample region across the target area by applying rasterisation.

In still further embodiments, the rendering unit generates ambient occlusion for the target area.

In embodiments, a method is provided for assigning world coordinates to at least one point in an image of a physical space captured at a time of capture by an image capture device, the method comprising a rendering unit: (i) ascertaining, for the time of capture, a focal length of the image capture device; (ii) determining, in world coordinates, for the time of capture, an orientation of the image capture device; (iii) determining, in world coordinates, for the time of capture, a distance between the image capture device and a reference point in the physical space; and (iv) generating a view transformation matrix comprising matrix elements determined by the focal length, the orientation and the distance to enable transformation between the coordinate system of the image and the world coordinates.

In further embodiments, a method is provided for space filling regions of an image, comprising the method for assigning world coordinates to at the least one point in the image of the physical space and comprising the rendering unit further: (i) selecting, based on user input, a sample region; (ii) mapping the sample region to a reference plane; (iii) generating a tileable representation of the sample region; (iv) selecting, based on user input, a target region in the reference plane; and (v) replicating the tileable representation of the sample region across the target region.

In still further embodiments, the rendering unit in the method for assigning world coordinates to at least one point in an image of the physical space determines the distance between the image capture device and the reference point by: (i) causing a reticule to be overlayed on the image using a display unit; (ii) obtaining from a user by a user input device the known length and orientation in world coordinates of a line corresponding to a captured feature of the physical space; (iii) adjusting the location and size of the reticule with respect to the image in response to user input on the user input device; (iv) obtaining from the user by the user input device an indication that the reticule is aligned with the line; and (v) determining the distance from the image capture device to the reference point, based on the size and orientation of the reticule and the size and orientation of the line.

In embodiments, the rendering unit in the method for assigning world coordinates to at least one point in an image of the physical space determines the distance from the image capture device to the reference point by: (i) determining that a user has placed the image capture device on a reference plane; (iii) determining the acceleration of the image capture device as the user moves the image capture device from the reference plane to an image capture position; (iv) deriving the distance of the image capture device from the reference plane from the acceleration; and (iv) determining the distance between the image capture device and the reference point, based on the focal length of the image capture device and the distance of the image capture device from the reference plane.

In further embodiments, the rendering unit in the method for assigning world coordinates to at least one point in an image of the physical space determines the distance from the image capture device to the reference point by requesting user input of an estimated distance from the image capture device to a reference plane.

In still further embodiments, the rendering unit in the method for assigning world coordinates to at least one point in an image of the physical space determines the orientation in world coordinates of the image capture device by: (i) obtaining acceleration of the image capture device from an accelerometer of the image capture device; (ii) determining from the acceleration when the image capture device is at rest; and (iii) assigning the acceleration at rest as a proxy for the orientation in world coordinates of the image capture device.

In embodiments, the rendering unit in the method for assigning world coordinates to at least one point in an image of the physical space generates the tileable representation of the sample region comprises by using a Poisson gradient-guided blending technique. In further embodiments, the tileable representation of the sample region comprises four sides and the rendering unit enforces identical boundaries for all four sides of the tileable representation of the sample region.

In yet further embodiments, the rendering unit in the method for assigning world coordinates to at least one point in an image of the physical space replicates the tileable representation of the sample region across the target area by applying rasterisation.

In embodiments, the rendering unit in the method for assigning world coordinates to at least one point in an image of the physical space further generates ambient occlusion for the target area.

### DESCRIPTION OF THE DRAWINGS

A greater understanding of the embodiments will be had with reference to the Figures, in which:

FIG. 1 illustrates an example of a system for space filling regions of an image;

FIG. 2 illustrates an embodiment of the system for space filling regions of an image;

FIG. 3 is a flow diagram illustrating a process for calibrating a system for space filling regions of an image;

FIGS. 4-6 illustrate embodiments of a user interface module for calibrating a system for space filling regions of an image;

FIG. 7 illustrates a flow diagram illustrating a process for space filling regions of an image; and

FIGS. 8-10 illustrate embodiments of a user interface module for space filling regions of an image.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media and executed by the one or more processors.

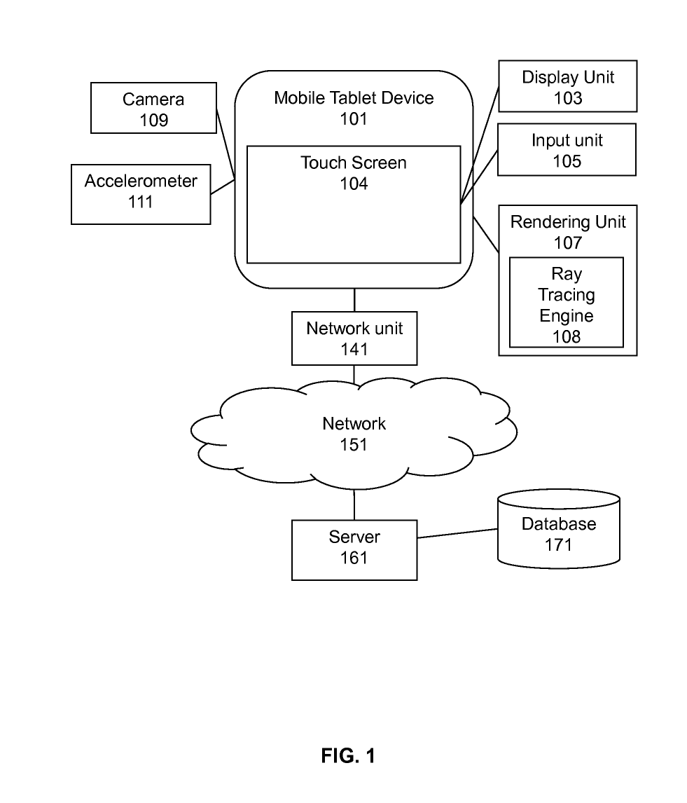

Referring now to FIG. 1, an exemplary embodiment of a system for space filling regions of an image of a physical space is depicted. In the depicted embodiment, the system is provided on a mobile tablet device 101. However, aspects of systems for space filling regions of an image may be provided on other types of devices, such as for, example, mobile telephones, laptop computers and desktop computers.

The mobile tablet device 101 comprises a touch screen 104. Where the mobile tablet device 101 comprises a touch screen 104, it will be appreciated that a display unit 103 and an input unit 105 are integral and provided by the touch screen 104. In alternate embodiments, however, the display unit and the input unit may be discrete units. In still further embodiments, the display unit and some elements of the user input unit may be integral while other input unit elements may be remote from the display unit. For example, the mobile tablet device 101 may comprise physical switches and buttons (not shown).

The mobile tablet device 101 further comprises: a rendering unit 107 employing a ray tracing engine 108; an image capture device 109, such as, for example, a camera or video camera; and an accelerometer 111. In embodiments, the mobile tablet device may comprise other suitable sensors (not shown).

The mobile tablet device may comprise a network unit 141 providing, for example, Wi-Fi, cellular, 3G, 4G, Bluetooth and/or LTE functionality, enabling network access to a network 151, such as, for example, the Internet or a local intranet. A server 161 may be connected to the network 151. The server 161 may be linked to a database 171 for storing data, such as models of furniture, finishes, floor coverings and colour swatches relevant to users of the mobile tablet device 101, users including, for example, architects, designers, technicians and draftspersons. In aspects, the actions described herein as being performed by the rendering unit may further or alternatively be performed outside the mobile tablet device by the server 161 on the network 151.

In aspects, one or more of the aforementioned components of the mobile tablet device 101 is in communication with, and remote from, the mobile tablet device 101.

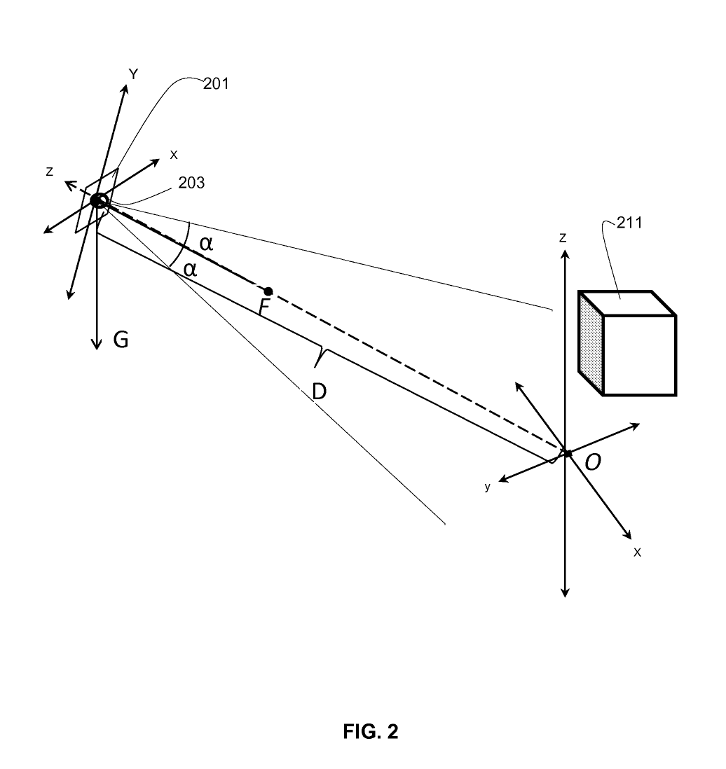

Referring now to FIG. 2, an image capture device 201 is shown pointing generally toward an object 211 in a physical space. The image capture device 201 has its own coordinate system defined by X-, Y- and Z-axes, where the Z-axis is normal to the image capture device lens 203 and where the X-, Y-, and Z-axes intersect at the centre of the image capture device lens 203. The image capture device 201 may capture an image which includes portions of at least some objects 211 having at least one known dimension, which fall within its field of view.

The field of view is defined by the view frustum, as shown. The view frustum is defined by: the focal length F along the image capture device Z-axis, and the lines emanating from the centre of the image capture device lens 203 at angles α to the Z-axis. On some image capture devices, including mobile tablet devices and mobile telephones, the focal length F and, by extension, the angles α, are fixed and known, or ascertainable. In certain image capture devices, the focal length F is variable but is ascertainable for a given time, including at the time of capture.

It will be appreciated that the rendering unit must reconcile multiple coordinate systems, as shown in FIG. 2, such as, for example, world coordinates, camera (or image capture device) coordinates, object coordinates and projection coordinates. The rendering unit is configured to model the image as a 3-dimensional (3D) space by assigning world coordinates to one or more points in the image of the physical space. The rendering unit assigns world coordinates to the one or more points in the image by generating a view transformation matrix that transforms points on the image to points having world coordinates, and vice versa. The rendering unit is operable to generate a view transformation matrix to model, for example, an image of a physical space appearing in 2D on the touchscreen of a mobile tablet device.

The rendering unit may apply the view transformation matrix to map user input gestures to the 3D model, and further to render design elements applied to the displayed image.

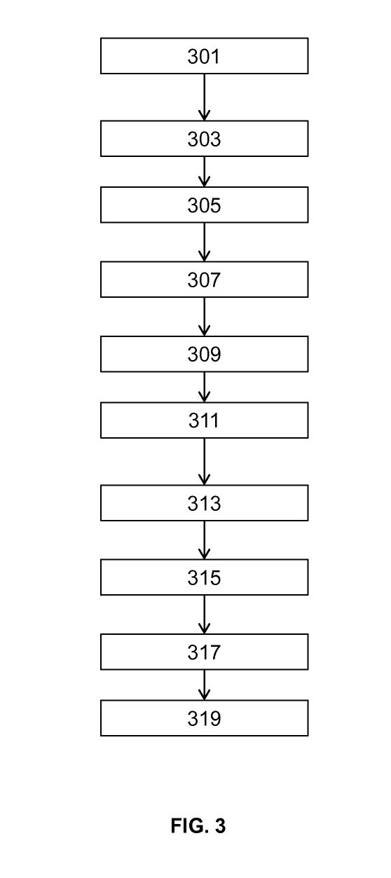

The view transformation matrix is expressed as the product of three matrices: VTM=N·T·R, where VTM is the view transformation matrix, N is a normalisation matrix, T is a translation matrix and R is a rotation matrix. In order to generate the view transformation matrix, the rendering unit must determine matrix elements through a calibration process, a preferred mode of which is shown in FIG. 3 and hereinafter described.

As shown in FIG. 3, at block 301, in a specific example, the user uses the image capture device to take a photograph, i.e., capture an image, of a physical space to which a design is to be applied. The application of a design may comprise, for example, removal and/or replacement of items of furniture, removal and/or replacement of floor coverings, revision of paint colours or other suitable design creations and modifications. The space may be generally empty or it may contain numerous items, such as, for example, furniture, people, columns and other obstructions, at the time the image is captured.

In FIG. 2, the image capture device is shown pointing generally downward in relation to world coordinates. In aspects, the rendering unit performs a preliminary query to the accelerometer while the image capture device is at rest in the capture position to determine whether the image capture device is angled generally upward or downward. If the test returns an upward angle, the rendering unit causes the display unit to display a prompt to the user to re-capture the photograph with the image capture device pointing generally downward.

At block 303, the rendering unit generates the normalisation matrix N, which normalises the view transformation matrix according to the focal length of the image capture device. As previously described, the focal length for a device having a fixed focal length is constant and known, or derivable from a constant and known half angle α. If the focal length of the image capture device is variable, the rendering unit will need to ascertain the focal length or angle of the image capture device for the time of capture. The normalisation matrix N is defined for a given half-angle α is defined as:

$$[ \begin{matrix}1 / tan α & 0 & 0 & 0 \\ 0 & 1 / tan α & 0 & 0 \\ 0 & 0 & 1 & 0 \\ 0 & 0 & 0 & 1\end{matrix} ] ,$$

where α is the half angle of the image capture device's field of view.

At block 305, the rendering unit generates the rotation matrix R. The rotation matrix represents the orientation of the image capture device coordinates in relation to the world coordinates. The image capture device comprises an accelerometer configured for communication with the rendering unit, as previously described. The accelerometer provides an acceleration vector G, as shown in FIG. 2. When the image capture device is at rest, any acceleration which the accelerometer detects is solely due to gravity. The acceleration vector G corresponds to the degree of rotation of the image capture device coordinates with respect to the world coordinates. At rest, the acceleration vector G is parallel to the world space z-axis. The rendering unit can therefore assign the acceleration at rest as a proxy for the orientation in world coordinates of the image capture device.

The rendering unit derives unit vectors NX and NY from the acceleration vector G and the image capture device coordinates X and Y:

$$\vec{NX} = \frac{\vec{Y} \times \vec{G}}{\vert \vec{Y} \times \vec{G} \vert}$$

$$\vec{NY} = \frac{\vec{G} \times \vec{NX}}{\vert \vec{G} \times \vec{NX} \vert} .$$

The resulting rotation vector appears as follows:

$$[ \begin{matrix}\vec{NX} \cdot x & \vec{NY} \cdot x & \vec{G} \cdot x & 0 \\ \vec{NX} \cdot y & \vec{NY} \cdot y & \vec{G} \cdot y & 0 \\ \vec{NX} \cdot z & \vec{NY} \cdot z & \vec{G} \cdot z & 0 \\ 0 & 0 & 0 & 1\end{matrix} ] .$$

At block 307, the rendering unit generates the translation matrix T. The translation matrix accounts for the distance at which the image capture device coordinates are offset from the world coordinates. The rendering unit assigns an origin point O to the view space, as shown in FIG. 2. The assigned origin projects to the centre of the captured space, i.e., along the image capture device Z-axis toward the centre of the image captured by the image capture device at block 301. The rendering unit assumes that the origin is on the “floor” of the physical space, and assigns the origin a position in world coordinates of (0, 0, 0). The origin is assigned a world space coordinate on the floor of the space captured in the image so that the only possible translation is along the image capture device's Z-axis. The image capture device's direction is thereby defined as: \vec{NX}·Z, \vec{NY}·Z, \vec{G}·Z, 0. The displacement along that axis is represented in the resulting translation matrix:

$$[ \begin{matrix}1 & 0 & 0 & 0 \\ 0 & 1 & 0 & 0 \\ 0 & 0 & 1 & D \\ 0 & 0 & 0 & 1\end{matrix} ] ,$$

where D represents the distance, for the time of capture, between the image capture device and a reference point in the physical space.

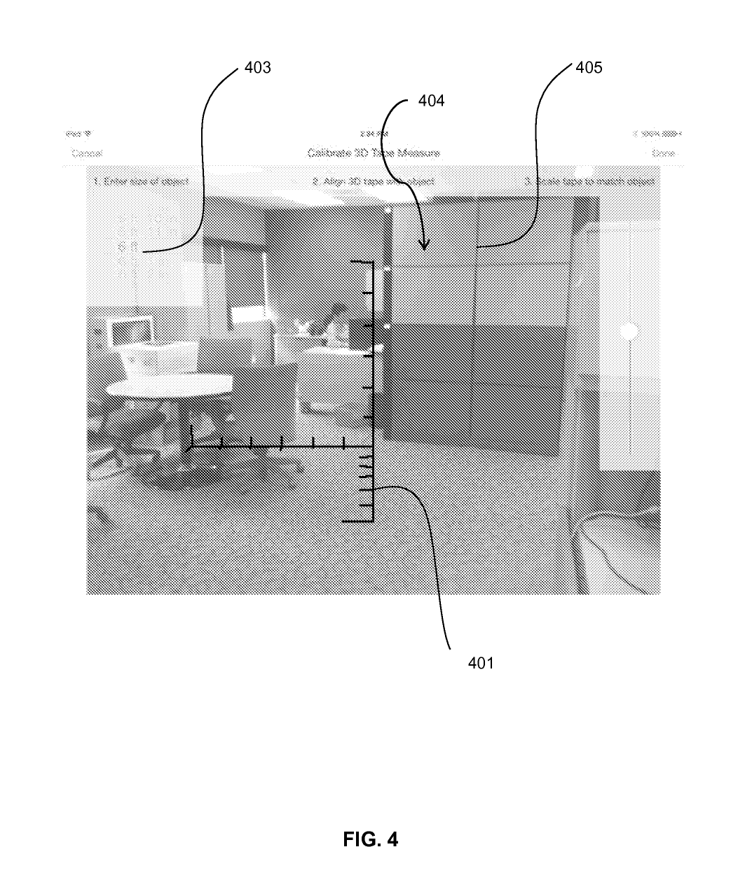

The value for D is initially unknown and must be ascertained through calibration or other suitable technique. At block 309, the rendering unit causes a reticule 401 to be overlaid on the image using the display unit, as shown in FIG. 4. The rendering unit initially causes display of the reticule to correspond to a default orientation, size and location, as shown. For example, the default size may be 6 feet, as shown at prompt 403.

As shown in FIGS. 3 and 4, at block 311 a prompt 403 is displayed on the display unit to receive from the user a reference dimension and orientation of a line corresponding to a visible feature within the physical space. For example, as illustrated in FIGS. 3 and 4, the dimension of the line may correspond to the distance in world coordinates between the floor and the note paper 405 on the dividing wall 404. In aspects, a visible door, bookcase or desk sitting on the floor having a height known to the user could be used as visible features. The user selects the size of the reference line by scrolling through the dimensions listed in the selector 403; the rendering unit will then determine that the reticule corresponds to the size of the reference line.

As shown in FIG. 4, the reticule 401 is not necessarily initially displayed in alignment with the reference object. As shown in FIG. 3, at blocks 313 to 317, the rendering unit receives from the user a number of inputs described hereinafter to align the reticule 401. At block 313, the rendering unit receives a user input, such as, for example, a finger gesture or single finger drag gesture, or other suitable input technique to translate the reticule to a new position. At block 315, the rendering unit determines the direction that a ray would take if cast from the image capture device to the world space coordinates of the new position by applying to the user input gesture the inverse of the previously described view transformation matrix. The rendering unit then determines the x- and y-coordinates in world space where the ray would intersect the floor (z=0). The rendering unit applies those values to calculate the following translation matrix that would bring the reticule to the position selected by the user:

$$[ \begin{matrix}1 & 0 & 0 & X \\ 0 & 1 & 0 & Y \\ 0 & 0 & 1 & 0 \\ 0 & 0 & 0 & 1\end{matrix} ]$$

At block 317, the rendering unit rotates the reticule in response to a user input, such as, for example, a two-finger rotation gesture or other suitable input. The rendering unit rotates the reticule about the world-space z-axis by angle θ by applying the following local reticule rotation matrix:

$$[ \begin{matrix}cos ( θ ) & - sin ( θ ) & 0 & 0 \\ sin ( θ ) & cos ( θ ) & 0 & 0 \\ 0 & 0 & 1 & 0 \\ 0 & 0 & 0 & 1\end{matrix} ]$$

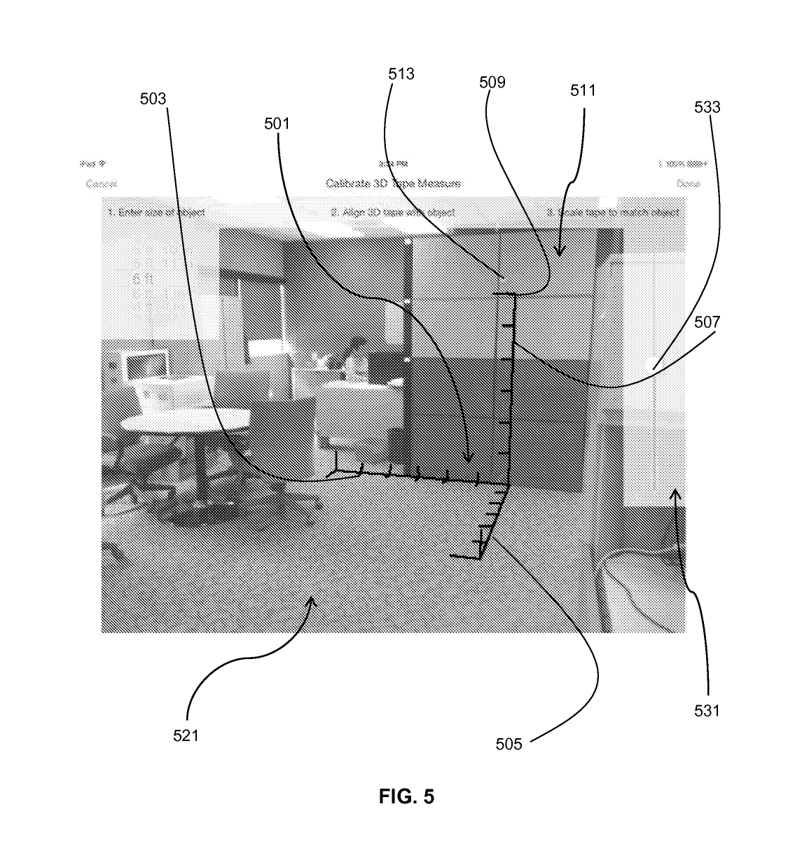

The purpose of this rotation is to align the reticule along the base of the reference object, as shown in FIG. 5, so that the orientation of the reticule is aligned with the orientation of the reference line. When the user has aligned the reticule 501 with the reference object 511, its horizontal fibre 503 is aligned with the intersection between the reference object 511 and the floor 521, its vertical fibre 507 extends vertically from the floor 521 toward, and intersecting with, the reference point 513, and its normal fibre 505 extends perpendicularly from the reference object 511 along the floor 521.

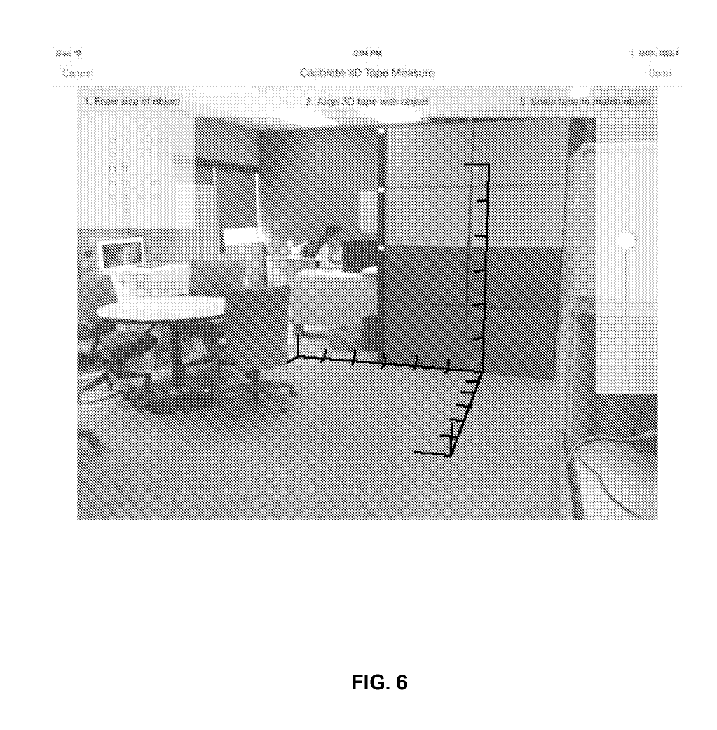

Recalling that the reticule was initially displayed as a default size to which the user assigned a reference dimension, as previously described, it will be appreciated that the initial height of the marker 509 may not necessarily correspond to the world coordinate height of the reference point 513 above the floor 521. Referring again to FIG. 3, at block 319, the rendering unit responds to further user input by increasing or decreasing the height of the marker 509. In aspects, the user adjusts the height of the vertical fibre 507 to align the marker 509 with the reference point 513 by, for example, providing a suitable touch gesture to slide a slider 531, as shown, so that the vertical fibre 507 increases or decreases in height as the user moves the slider bead 533 up or down, respectively; however, other input methods, such as arrow keys on a fixed keyboard, or mouse inputs could be implemented to effect the adjustment. Once the user has aligned the marker 509 of the reticule 507 with the reference point 513, the rendering unit can use the known size, location and orientation of each of the reticule and the line to solve the view transformation matrix for the element D. A fully calibrated space is shown in FIG. 6.

Once the rendering unit has determined the view transformation matrix, the rendering unit may begin receiving design instructions from the user and applying those changes to the space.

In further aspects, other calibration techniques may be performed instead of, or in addition to, the calibration techniques described above. In at least one aspect, the rendering unit first determines that a user has placed the image capture device on the floor of the physical space. Once the image capture device is at rest on the floor, the user lifts it into position to capture the desired image of the physical space. As the user moves the device into the capture position, the rendering unit determines the distance from the image capture device to the floor based on the acceleration of the image capture device. For example, the rendering unit calculates the double integral of the acceleration vector over the elapsed time between the floor position and the capture position to return the displacement of the image capture device from the floor to the capture position. The accelerometer also provides the image capture device angle with respect to the world coordinates to the rendering unit once the image capture device is at rest in the capture position, as previously described. With the height, focal length, and image capture device angle with respect to world coordinates known, the rendering unit has sufficient data to generate the view transformation matrix.

In still further aspects, the height of the image capture device in the capture position is determined by querying from the user the user's height. The rendering unit assumes that the image capture device is located a distance below the user's height, such as for example, 4 inches, and uses that location as the height of the image capture device in the capture position.

Alternatively, the rendering unit queries from the user an estimate of the height of the image capture device from the floor.

It will be appreciated that the rendering unit may also default to an average height off the ground, such as, for example, 5 feet, if the user does not wish to assist in any of the aforementioned calibration techniques.

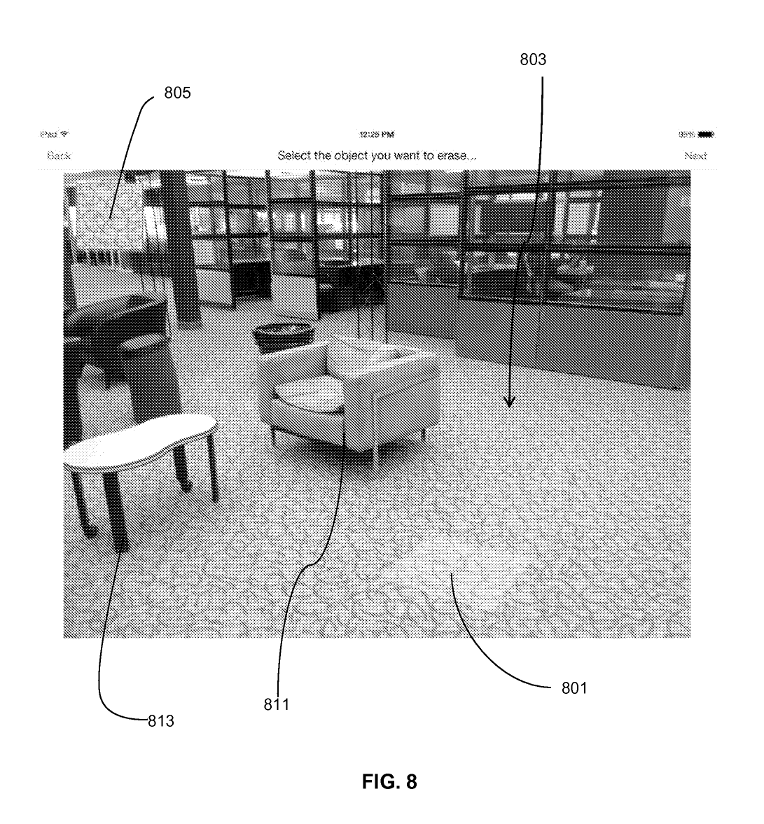

In aspects, the user may wish to apply a new flooring design to the image of the space, as shown in FIG. 8; however, the captured image of the space may comprise obstacles, such as, for example the chair 811 and table 813 shown. If the user would like to view a rendering of the captured space without the obstacles, the rendering unit needs to space fill the regions on the floor where the obstacles formerly stood.

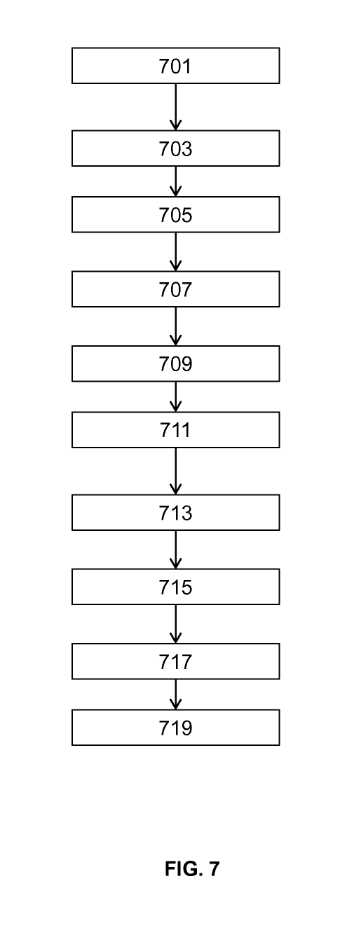

In FIG. 7, a flowchart illustrates a method for applying space filling regions of the captured image. At block 701, the user selects a sample region to replicate across a desired region in the captured image. As shown in FIG. 8, the rendering unit causes the display unit to display a square selector 801 mapped to the floor 803 of the captured space. The square selector 801 identifies the sample region of floor 803. In aspects, the square selector 801 is semi-transparent to simultaneously illustrate both its bounding area and the selected pattern, as shown. In alternate embodiments, however, the square selector 801 may be displayed as a transparent region with a defined border (not shown). In further aspects, a viewing window 805 is provided to display the selected area to the user at a location on the display unit, as shown. The rendering unit translates and flattens the pixels of the sample region bounded by the square selector 801 into the viewing window 805, and, in aspects, updates the display in real-time according to the user's repositioning of the selector.

The user may: move the selector 801 by dragging a finger or cursor over the display unit; rotate the selector 801 using two-finger twisting input gestures or other suitable input; and/or scale the selector 801 by using, for example, a two-finger pinch. As show in FIG. 7 at block 703, the rendering unit applies the following local scaling matrix to scale the selector:

$$[ \begin{matrix}S & 0 & 0 & 0 \\ 0 & S & 0 & 0 \\ 0 & 0 & S & 0 \\ 0 & 0 & 0 & 1\end{matrix} ]$$

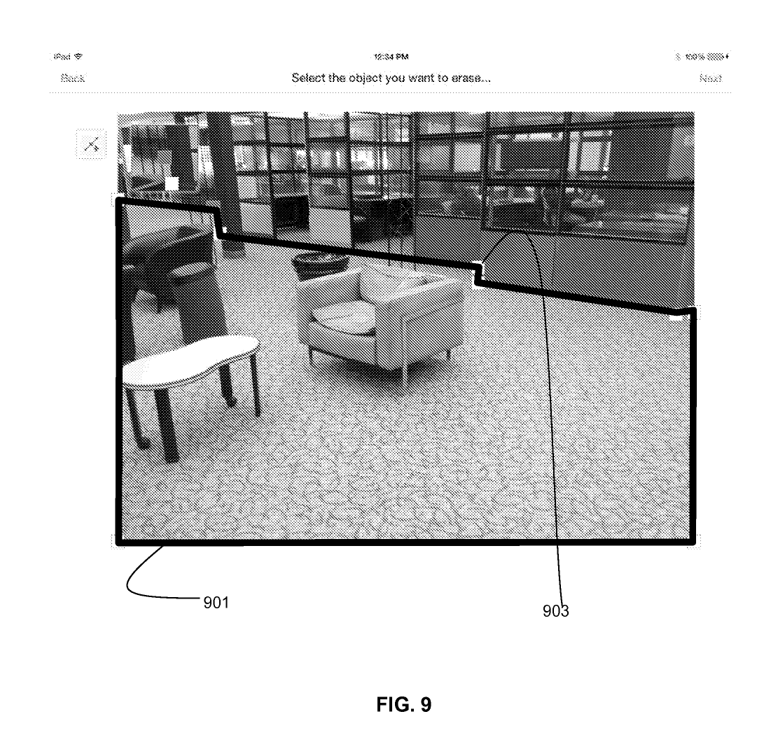

Once the user has selected a sample region to replicate, the user defines a target region in the image of the captured space to which to apply the pattern of the sample region, at block 705 shown in FIG. 7. The rendering unit causes a closed, non-self intersecting vector-based polygon 901 to be displayed on the display unit, as shown in FIG. 9. In order to ensure that the polygon 901 always defines an area, rather than a line, the polygon 901 comprises at least three control points 903. The user may edit the polygon 901 by adding, removing and moving the control points 903 using touch gestures or other suitable input methods, as described herein. In aspects, the control points 903 can be moved individually or in groups. In still further aspects, the control points may 903 be snapped to the edges and corners of the captured image, providing greater convenience to the user.

After the user has finished configuring the polygon, the rendering unit applies the pattern of the selected region to the selected target region, as shown in FIG. 7 at blocks 707 and 709. At block 707, the rendering unit generates a tileable representation of the pattern in the sample region, using suitable techniques, such as, for example, the Poisson gradient-guided blending technique described in Patrick Pérez, Michel Gangnet, and Andrew Blake. 2003. Poisson image editing. In ACM SIGGRAPH 2003 Papers (SIGGRAPH '03). ACM, New York, N.Y., USA, 313-318, incorporated herein by reference. Given a rectangular sample area, such as the area bounded by the selector 801 shown in FIG. 8, the rendering unit generates a tileable, i.e., repeatable, representation of the sample region by setting periodic boundary values on its borders. In aspects, the rendering unit enforces identical boundaries for all four sides of the square sample region. When the tileable representation is replicated, as described below, the replicated tiles will thereby share identical boundaries with adjacent tiles, reducing the apparent distinction between tiles.

At block 709, the rendering unit replicates the tile across the target area by applying rasterisation, such as, for example, the OpenGL rasteriser, and applying the existing view transformation matrix to the vector-based polygon 901, shown in FIG. 9 using a tiled texture map consisting of repeated instances of the tileable representation described above.

In aspects, the rendering unit enhances the visual accuracy of the modified image by generating ambient occlusion for the features depicted therein, as shown in at blocks 711 to 7. The rendering unit generates the ambient occlusion in cooperation with a ray tracing engine. At block 719, the rendering unit receives from the ray tracing engine ambient occlusion values, which it blends with the rasterised floor surface. In aspects, the rendering unit further enhances visual appeal and realism by blending the intersections of the floor and the walls from the generated image with those shown in the originally captured image.

At block 711, the rendering unit infers that the polygon 901, as shown in FIG. 9, represents the floor of the captured space, and that objects bordering the target region are wall surfaces. The rendering unit applies the view transformation matrix to determine the world space coordinates corresponding to the display coordinates of the polygon 901 and generates a 3D representation of the space by extruding virtual walls perpendicularly from the floor along the edges of the polygon 901. As shown in FIG. 7 at block 713, the rendering unit provides the resulting virtual geometries to a ray tracing engine. The rendering unit only generates virtual walls that meet the following condition: the virtual walls must face toward the inside of the polygon 901, and the virtual walls must face the user, i.e., towards the image capture device. These conditions are necessary to ensure that the rendering unit does not extrude virtual walls that would obscure the rendering, as will be appreciated below.

The rendering unit determines the world coordinates of the bottom edge of a given virtual wall by projecting two rays from the image capture device to the corresponding edge of the target area. The rays provide the world space x and y coordinates for the virtual wall where it meets the floor, i.e., at z=0. The rendering unit determines the height for the given virtual wall by projecting a ray through a point on the upper border of the display unit directly above the display coordinate of one of the end points of the corresponding edge. The ray is projected along a plane that is perpendicular to the display unit and that intersects the world coordinate of the end point of the corresponding edge. The rendering unit calculates the height of the virtual wall as the distance between the world coordinate of the end point and the world coordinate the ray directly above the end point.

In cooperation with the rendering unit, the ray tracing engine generates an ambient occlusion value for the floor surface. At block 713, the rendering unit transmits the virtual geometry generated at block 711 to the ray tracing engine. At block 715, the ray tracing engine casts shadow rays from a plurality of points on the floor surface toward a vertical hemisphere. For a given point, any ray emanating therefrom which hits one of the virtual walls represents ambient lighting that would be unavailable to that point. The proportion of shadow rays from the given point that would hit a wall to the shadow rays that would not hit a wall is a proxy for the level of ambient light at the given point on the floor surface.

Because the polygon may only extend to the borders of the display unit, any virtual walls extruded from the edges of the polygon will similarly only extend to the borders of the display unit. However, this could result in unrealistic brightening during ray tracing, since the shadow rays cast from points on the floor space toward the sides of the display unit will not encounter virtual walls past the borders. Therefore, in aspects, the rendering unit extends the virtual walls beyond the borders of the display unit in order to reduce the unrealistic brightening.

In aspects, the ray tracing engine further enhances the realism of the rendered design by accounting for colour bleeding, at block 717. The ray tracing engine samples the colour of the extruded virtual walls at the points of intersection of the extruded virtual walls with all the shadow rays emanating from each point on the floor. For a given point on the floor, the ray tracing engine calculates the average of the colour of all the points of intersection for that point on the floor. The average provides a colour of virtual light at that point on the floor.

In further aspects, the ray tracing engine favours generating the ambient occlusion for the floor surface, not the extruded virtual geometries. Therefore, the ray tracing engine casts primary rays without testing against the extruded geometry; however, the ray tracing engine tests the shadow rays against the virtual walls of the excluded geometry. This simulates the shadow areas of low illumination typically encountered where the virtual walls meet the floor surface.

It will be appreciated that ray tracing incurs significant computational expense. In aspects, the ray tracing engine reduces this expense by calculating the ambient occlusion at a low resolution, such as, for instance, at 5 times lower resolution than the captured image. The rendering unit then scales up to the original resolution the ambient occlusion obtained at lower resolution. In areas where the ambient occlusion is highly variable from one sub-region to the next, the rendering unit applies a bilateral blurring kernel to prevent averaging across dissimilar sub-regions.

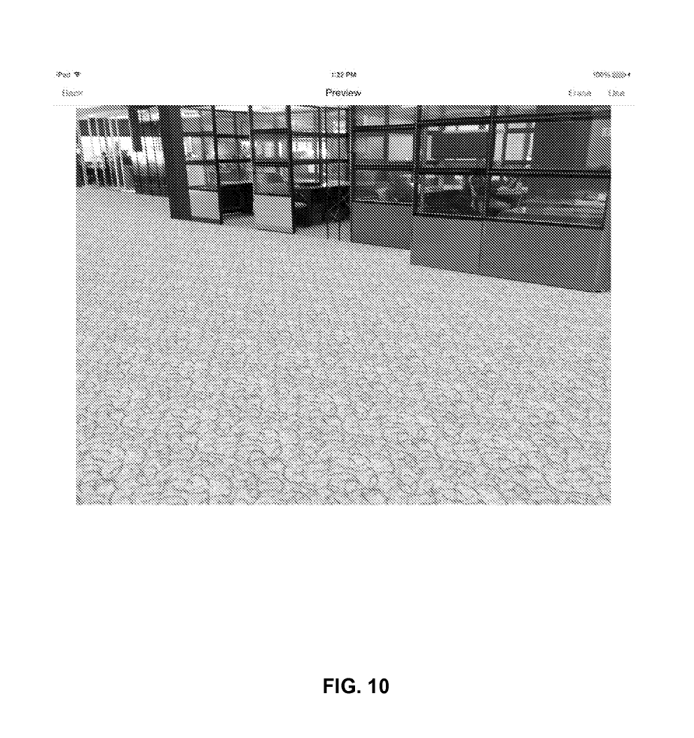

As shown in FIG. 10, the systems and methods described herein for space-filling regions of the captured image provide an approximation of the captured space with the obstacles removed.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A system for assigning world coordinates to at least one point in an image of a physical space captured at a time of capture by an image capture device, the system comprising a rendering unit configured to:
ascertain, for the time of capture, a focal length of the image capture device;
determine, in world coordinates, for the time of capture, an orientation of the image capture device;
determine, in world coordinates, for the time of capture, a distance between the image capture device and a reference point in the physical space; and
generate a view transformation matrix comprising matrix elements determined by the focal length, the orientation and the distance to enable transformation between the coordinate system of the image and the world coordinates.

2. The system of claim 1, wherein the system is configured to space fill regions of the image, the rendering unit being further configured to:
select, based on user input, a sample region in the image;
map the sample region to a reference plane;
generate a tileable representation of the sample region;
select, based on user input, a target region in the reference plane; and
replicate the tileable representation of the sample region across the target region.

3. The system of claim 1, wherein the rendering unit is configured to determine the distance between the image capture device and the reference point by:
causing a reticule to be overlaid on the image using a display unit;
obtaining from a user by a user input device the known length and orientation in world coordinates of a line corresponding to a captured feature of the physical space;
adjusting the location and size of the reticule with respect to the image in response to user input provided by the user input device;
obtaining from the user by the user input device an indication that the reticule is aligned with the line; and
determining the distance from the image capture device to the reference point, based on the size and orientation of the reticule and the size and orientation of the line.

4. The system of claim 1, wherein the rendering unit is configured to determine the distance from the image capture device to the reference point by:
determining that a user has placed the image capture device on a reference plane;
determining the acceleration of the image capture device as the user moves the image capture device from the reference plane to an image capture position;
deriving the distance of the image capture device from the reference plane from the acceleration; and
determining the distance between the image capture device and the reference point, based on the focal length of the image capture device and the distance of the image capture device from the reference plane.

5. The system of claim 1, wherein the rendering unit is configured to determine the distance from the image capture device to the reference point by requesting user input of an estimated distance from the image capture device to a reference plane.

6. The system of claim 1, wherein the rendering unit determines the orientation in world coordinates of the image capture device by:
obtaining acceleration of the image capture device from an accelerometer of the image capture device;
determining from the acceleration when the image capture device is at rest; and
assigning the acceleration at rest as a proxy for the orientation in world coordinates of the image capture device.

7. The system of claim 2, wherein the rendering unit generates the tileable representation of the sample region by using a Poisson gradient-guided blending technique.

8. The system of claim 7, wherein the tileable representation of the sample region comprises four sides and the rendering unit enforces identical boundaries for all four sides of the tileable representation of the sample region.

9. The system of claim 2, wherein the rendering unit replicates the tileable representation of the sample region across the target area by applying rasterisation.

10. The system of claim 2, wherein the rendering unit generates ambient occlusion for the target area.

11. A method for assigning world coordinates to at least one point in an image of a physical space captured at a time of capture by an image capture device, the method comprising:
a rendering unit:
ascertaining, for the time of capture, a focal length of the image capture device;
determining, in world coordinates, for the time of capture, an orientation of the image capture device;
determining, in world coordinates, for the time of capture, a distance between the image capture device and a reference point in the physical space; and
generating a view transformation matrix comprising matrix elements determined by the focal length, the orientation and the distance to enable transformation between the coordinate system of the image and the world coordinates.

12. The method of claim 11 for space filling regions of the image, the method comprising:
the rendering unit further:
selecting, based on user input, a sample region;
mapping the sample region to a reference plane;
generating a tileable representation of the sample region;
selecting, based on user input, a target region in the reference plane; and
replicating the tileable representation of the sample region across the target region.

13. The method of claim 11, wherein the rendering unit determines the distance between the image capture device and the reference point by:
causing a reticule to be overlayed on the image using a display unit;
obtaining from a user by a user input device the known length and orientation in world coordinates of a line corresponding to a captured feature of the physical space;
adjusting the location and size of the reticule with respect to the image in response to user input on the user input device;
obtaining from the user by the user input device an indication that the reticule is aligned with the line; and
determining the distance from the image capture device to the reference point, based on the size and orientation of the reticule and the size and orientation of the line.

14. The method of claim 11, wherein the rendering unit determines the distance from the image capture device to the reference point by:
determining that a user has placed the image capture device on a reference plane;
determining the acceleration of the image capture device as the user moves the image capture device from the reference plane to an image capture position;
deriving the distance of the image capture device from the reference plane from the acceleration; and
determining the distance between the image capture device and the reference point, based on the focal length of the image capture device and the distance of the image capture device from the reference plane.

15. The method of claim 11, wherein the rendering unit is configured to determine the distance from the image capture device to the reference point by requesting user input of an estimated distance from the image capture device to a reference plane.

16. The method of claim 11, wherein the rendering unit determines the orientation in world coordinates of the image capture device by:
obtaining acceleration of the image capture device from an accelerometer of the image capture device;
determining from the acceleration when the image capture device is at rest; and
assigning the acceleration at rest as a proxy for the orientation in world coordinates of the image capture device.

17. The method of claim 12, wherein the rendering unit generates the tileable representation of the sample region comprises by using a Poisson gradient-guided blending technique.

18. The method of claim 17, wherein the tileable representation of the sample region comprises four sides and the rendering unit enforces identical boundaries for all four sides of the tileable representation of the sample region.

19. The method of claim 12, wherein the rendering unit replicates the tileable representation of the sample region across the target area by applying rasterisation.

20. The method of claim 12, further comprising the rendering unit generating ambient occlusion for the target area.
